(19) United States
(12) Patent Application Publication
(10) Pub. No.: US 2024/0176633 A1
(43) Pub. Date: May 30, 2024

(54) SYSTEM AND METHOD FOR IN-LINE EXECUTABLES

(71) Applicant: Grid.ai, Inc., New York, NY (US)

(72) Inventors: Williams Falcon, New York, NY (US); Richard Izzo, New York, NY (US)

(21) Appl. No.: 18/505,653

(22) Filed: Nov. 9, 2023

Related U.S. Application Data
(60) Provisional application No. 63/428,503, filed on Nov. 29, 2022.

(51) Int. Cl. G06F 9/455; G06F 8/41; G06F 8/61; G06F 9/38; G06F 40/279

(52) U.S. Cl. CPC G06F 9/45508; G06F 8/4443; G06F 8/61; G06F 9/3838; G06F 40/279

(57) ABSTRACT

In variants, the method and/or system for executing a polyglot script can include identifying a line including a special character in a base script; executing commands within the special character line using a secondary CIEM; optionally repeating the above for subsequent lines in the base script including the special character; and executing the remainder of the base script using a primary CIEM S500.

### CROSS-REFERENCE TO RELATED APPLICATIONS

This application claims the benefit of U.S. Provisional Application No. 63/428,503 filed 29 Nov. 2022, each of which is incorporated in its entirety by this reference.

### TECHNICAL FIELD

This invention relates generally to the programming field, and more specifically to a new and useful script interpretation method in the programming field.

### BRIEF DESCRIPTION OF THE FIGURES

FIG. 1 is a schematic representation of a variant of the method.

FIG. 2 is a schematic representation of a variant of the system.

FIG. 3 is an illustrative example of the command executing the primary interpreter, the base script, and the secondary interpreter executing the secondary interpreter directives.

FIGS. 4A-4C are illustrative examples of base scripts.

FIG. 5 is an illustrative example of executing the base script without executing the secondary interpreter directives (e.g., “lightning run app run_ptl_script.py”) and executing the base script with executing the secondary interpreter directives (e.g., “lightning run app run_ptl_script.py -- setup”).

### DETAILED DESCRIPTION

The following description of the embodiments of the invention is not intended to limit the invention to these embodiments, but rather to enable any person skilled in the art to make and use this invention.

### 1. Overview

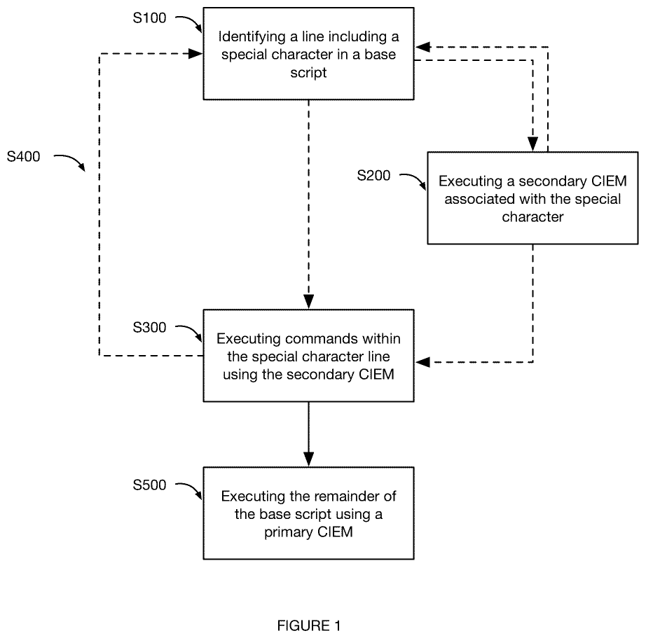

In variants, as shown in FIG. 1, the method for in-line executables can include: identifying a line including a special character in a base script S100; executing a secondary CIEM associated with the special character S200; executing commands within the special character line using the secondary CIEM S300; optionally repeating S100-S300 for subsequent lines in the base script including the special character S400; and executing the remainder of the base script using a primary CIEM S500. The method functions to enable interpretation of a polyglot script (e.g., computer script, computer program, etc.).

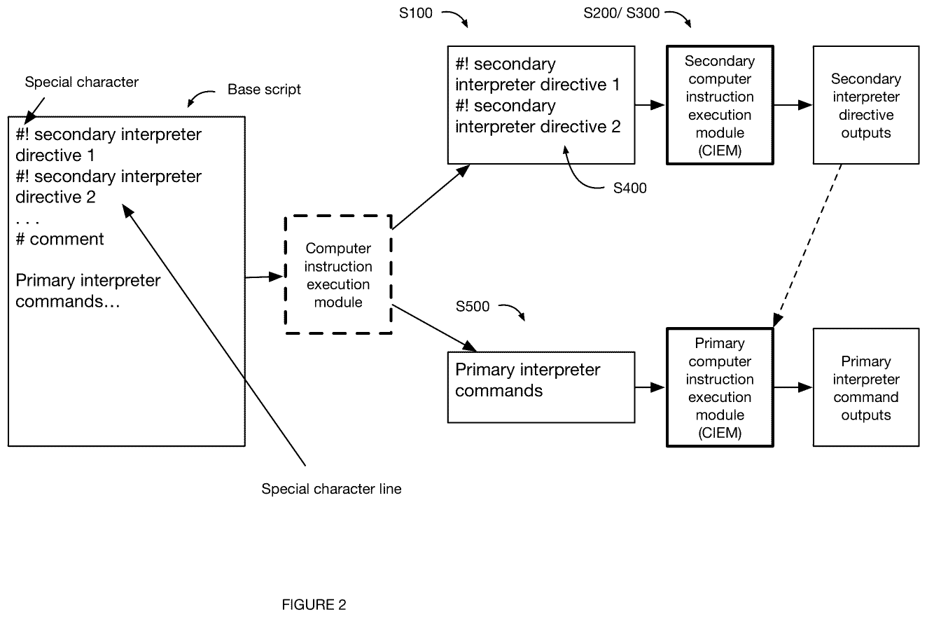

In an example (e.g., shown in FIG. 2), script lines starting with a special character (e.g., magic number; “#!”; etc.) can be detected in a base script (e.g., by a program loader, an interpreter, etc.); a secondary interpreter can optionally be automatically loaded when the special character is detected (e.g., a session of the secondary interpreter can be automatically initialized); and everything on the line after the special character can be interpreted as a command for the secondary interpreter, wherein the command is executed (e.g., run) in the secondary interpreter session (e.g., run by the secondary interpreter). In variants, the special character line can include one or more commands, wherein different commands can be separated by a reserved character (e.g., the same or different from the special character) or not delineated. Subsequent lines in the base script including (e.g., starting with) the special character can also be treated as commands for the secondary interpreter, and can optionally be executed in the same secondary interpreter session. Other lines in the base script that do not start with the special character can be executed by the primary interpreter. The commands in the special character line can be in the same or different computing language as the commands in the remainder of the script. In variants, the one or more special character lines can be located anywhere in the base script, and are not required to be in the first line of the base script. In variants, the special character line(s) can omit an identifier (e.g., filepath, name, etc.) for the secondary interpreter (e.g., not specify the secondary interpreter), wherein a default secondary interpreter can be automatically used, or include a secondary interpreter identifier (e.g., immediately following the special character, after a text blob within the special character line, etc.). In variants, the secondary interpreter can be specific to the operating system (OS) or kernel executing the program (e.g., wherein the secondary interpreter can be automatically selected from a set of secondary interpreters based on the OS or kernel), be a generic secondary interpreter (e.g., generic across operating systems and/or kernels), and/or be otherwise generic or specific.

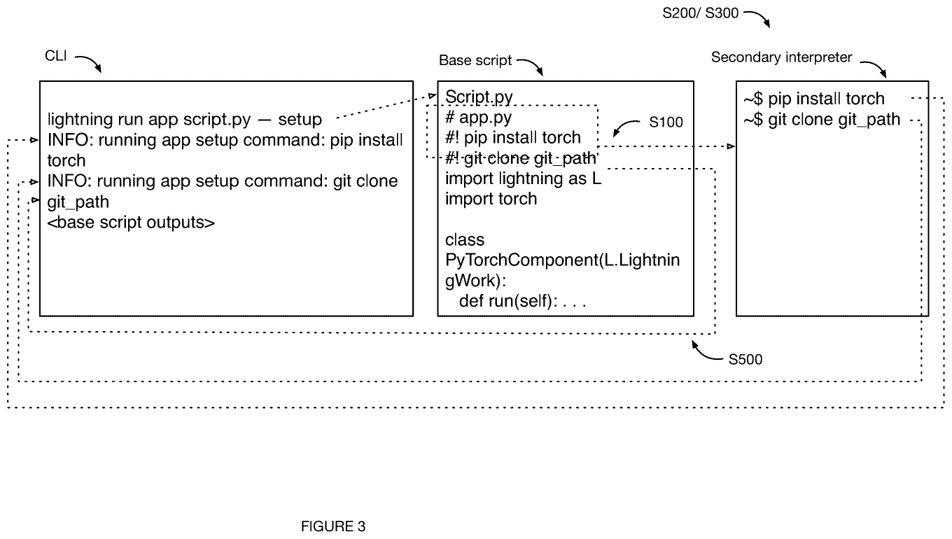

In an illustrative example, a computing system component (e.g., the operating system, the operating system kernel, the programming language kernel, the shell, the program loader, the assembler, the compiler, the interpreter, etc.) can detect “#!” (the special character) in a Python script (the base script), automatically load a Bash session (the default secondary interpreter), treat the character-delineated text blobs following the “#!” as Bash commands, execute the Bash commands in the Bash session, and continue to load and/or execute the Python script lines following the “#!” line using the primary interpreter (e.g., Python interpreter; example shown in FIG. 3). Python script execution is preferably paused during Bash command execution, but can alternatively execute concurrently. Subsequent lines in the Python script starting with “#!” can be executed in the same or different Bash session.

However, the method can be otherwise performed.

### 2. Technical Advantages

Variants of the technology can confer benefits over conventional systems.

First, variants of the technology can provide a simplified, flexible mechanism for script execution. For example, variants of the technology can enable a user to both set up a program's computing environment and execute the program using a single-file, self-contained script, which can enable a single file to the shipped (e.g., without shipping other files, other libraries, other dependencies, etc.). This can remove the traditional need for a separate requirements text file delineating all necessary packages, documentation of package and project dependency settlement, and a precomputed image of the computing environment, in addition to the script itself. Instead, documentation recommending moving and transferring files and folders into a particular best-practice architecture can be done automatically for the user by the execution of a single script. In an illustrative example, commands within the special character lines in the script can be used to download libraries, set up dependencies, specify interpreters (e.g., primary interpreters, secondary interpreters, etc.), and/or otherwise set up the computing environment before running the remainder of the script. In another illustrative example, commands within the same script can be executed (e.g., in parallel, in series, etc.) by multiple different interpreters (e.g., shells, programming language kernel, etc.), which can enable the same script to control different parts of the computing system (e.g., different machine components, different isolation levels, different machine levels, etc.) using different mechanisms (e.g., different programming languages, different machine languages, etc.).

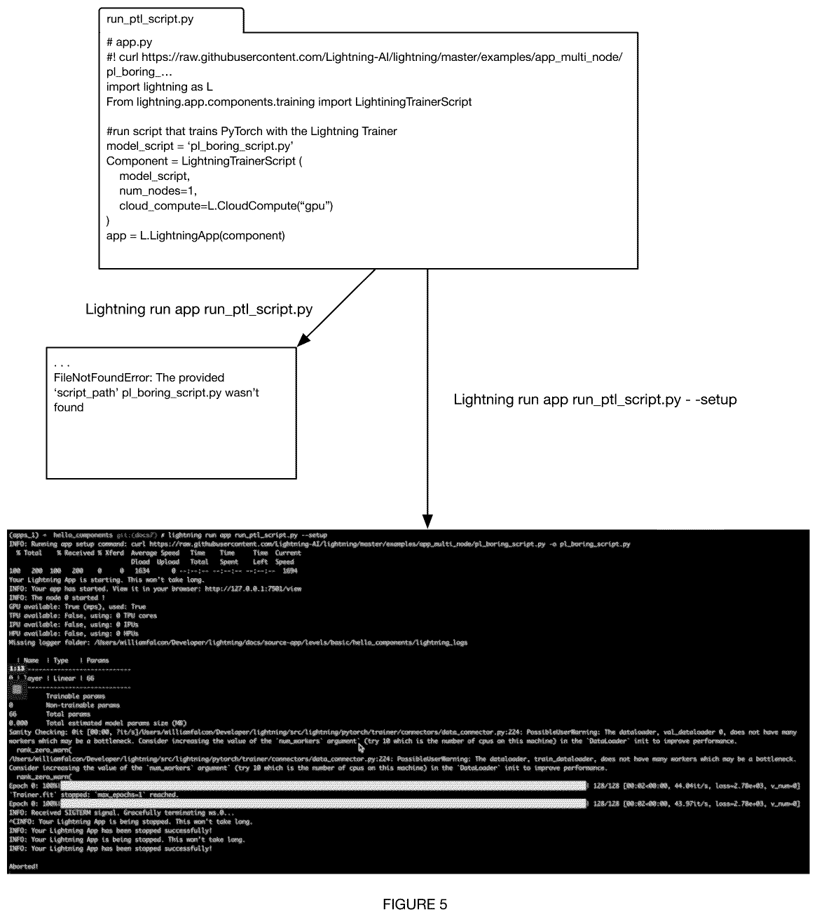

Second, variants of the technology can enable more flexible mechanisms for interacting with secondary interpreters. For example, variants of the technology can enable more special character lines to be used (e.g., instead of limiting the special character lines to the initial line of a script or file), such as by using a loader configured to interpret any line including (e.g., starting with) the special character as a secondary interpreter directive. This can enable a user to effectively write two different scripts (e.g., for two different interpreters) in the same file, and can eliminate the need for a user to write a separate requirement file and/or separately set up the execution environment in a separate program or shell before base script execution (shown in FIG. 5). For example, this technology allows all dependencies to be downloaded, installed, properly packaged, and used by running the single file, as compared to traditional methods of setting up the project packages individually and separately from the invocation of the base script, incurring additional time and expense. This, in turn, can reduce user execution error and increase usability. In specific examples, the technology can use a preinstalled, standard computer instruction execution module (e.g., a Bash shell, etc.) as the secondary interpreter (e.g., secondary CIEM), which removes the need for a script to be run by a special interpreter or shell (e.g., the user is not required to use the iPython shell).

Third, variants of the technology can enable all special character lines to be treated as arguments within the same secondary interpreter session, which can simplify secondary interpreter commands (e.g., subsequent secondary interpreter commands do not need to reinstate the session state established by the prior secondary interpreter commands). In variants, this is accomplished by using a default secondary interpreter, by limiting the user's secondary interpreter choices (e.g., to a single secondary interpreter), by using a previously-specified secondary interpreter to execute subsequent commands in the same or subsequent special character lines, and/or otherwise accomplished.

Fourth, variants of the technology can enable cross operating system (e.g., cross-OS) capability, wherein the same script and special character line commands can be executed on different operating systems and/or kernels (e.g., executed in the same manner, executed in the same order, produce the same output, etc.). In variants, this can make scripting easier for users to use, since script execution can be agnostic to any particular operating system or computing environment (e.g., by using computing environment-agnostic CIEMs, by using a set of CIEMs that are browser-based, by automatically selecting the CIEM for the computing environment, etc.). In examples, the calling shell (e.g., shell executing the script) can select and initialize an operating system-specific secondary interpreter for the special character lines, based on the operating system associated with the calling shell. In other examples, the calling shell can interpret the special character line command itself, and determine the operating system-specific secondary interpreter based on the type of command (e.g., the command format, etc.). In an illustrative example, the calling shell can identify a special character line “#! /usr/bin/env python3”, determine that the command is specific to the MacOS operating system (e.g., because “/usr/bin/env” was used), and optionally call a MacOS-specific interpreter to execute the command. If the command were “#! python3”, the calling shell would interpret the command to be specific to the Windows operating system, and optionally call a Windows-specific interpreter to execute the command. In further examples, the calling shell or secondary interpreter can convert operating system-specific commands for another operating system into operating system-specific commands for the host operating system (e.g., convert “#! /usr/bin/env python3” to “#! python3” when the host operating system is a Windows operating system). In other examples, OS-specific calls for operating systems different from the host OS can be ignored or otherwise handled. In variants, the calling shell can be specific to the operating system, or be agnostic to the operating system. The primary interpreter used by the calling shell can also be specific to the operating system, or be agnostic to the operating system. This can significantly improves upon the convenience and ease of code sharing and collaborating.

Sixth, variants of the technology can enable in-line executables and/or polyglot commands without the need to use specialized command shells, interpreters, and/or kernels (e.g., without using an iPython notebook; without using a Jupyter notebook; without using an iPython “kernel”, which is a shell; etc.). In examples, this can be enabled by a set of plugins, libraries, secondary interpreters, or standard executables installed on or otherwise accessible: by the computing environment; by a resource accessible by the interpreter executing the script (e.g., a web resource, etc.); by a custom shell (e.g., that includes the secondary interpreter(s) and the primary interpreter, that only includes the secondary interpreter(s), etc.); by passing the in-line executables into a subprocess (e.g., a Python subprocess, custom subprocess, etc.); by the calling shell (e.g., be a default interpreter for the shell); and/or otherwise enabled. Additionally or alternatively, the secondary interpreter can be: a preloaded (e.g., preinstalled) interpreter (e.g., standard interpreter, such as a Bash interpreter, preloaded custom interpreter, etc.); be a set of interpreters shipped with the script; and/or be any other suitable interpreter set. In an illustrative example, the special character line commands can be passed into a Python subprocess, wherein the cross-platform subprocess implementation in Python is leveraged for special character line command execution (e.g., to avoid over-reliance on the OS).

However, further advantages can be provided by the technologies disclosed herein.

### 3. System

In variants, the system can include or be used with one or more computer instruction execution modules (CIEMs), a set of scripts, and/or any other suitable element. The system functions to execute a set of commands in one or more programming languages that are contained in the same script.

The script (e.g., program, executable, file, etc.) functions to define a set of computer commands (e.g., executables, in-line executables, etc.). The system can execute one or more scripts. The scripts can be written by: users, entities, autonomous systems (e.g., machine learning systems, etc.), and/or any other suitable author.

The script is preferably a single file (e.g., example shown in FIG. 2), but can additionally or alternatively be multiple files.

The script can include a set of commands. The set of commands are preferably ordered, but can alternatively be unordered. The execution order can be specified by the order of command appearance within the script (e.g., order of the lines, order of the commands, etc.), be specified by a graph order (e.g., hierarchy), be specified by command set membership (e.g., secondary commands are executed first, non-primary commands are executed first, primary commands are executed first, etc.), and/or otherwise specified. Additionally or alternatively, the commands can be concurrently executed (e.g., in parallel). The set of commands are preferably executed in order, but can alternatively be executed out of order (e.g., wherein subsequent lines can be executed before preceding lines).

The commands within the script are preferably arranged in one or more lines, but can be otherwise arranged within the script. Each line can include one or more commands. A line can additionally or alternatively: include a special character (e.g., as the lead character(s), in the body of the line, etc.), specify a CIEM (e.g., after the special character), specify a filepath (e.g., to a CIEM, a resource, etc.), and/or include any other suitable information. In a first example, a line can include a special character, optionally include a CIEM identifier (e.g., an interpreter identifier), and include one or more commands, wherein a secondary CIEM (e.g., the identified CIEM or a default CIEM) can execute the one or more commands (e.g., in line order, in logical order, etc.). In a second example, a line can include a special character, optionally include a CIEM identifier, include a first set of commands, include a second CIEM identifier, and include a second set of commands, wherein a first secondary CIEM (e.g., the first identified CIEM or a default CIEM) can execute the first set of commands, and the second CIEM can execute the second set of commands. In a third example, a line can omit a special character and/or a CIEM identifier but include one or more commands, wherein the line is treated as a set of primary commands and is executed by the primary CIEM. However, the lines can be otherwise constructed and include any other suitable set of information.

The set of commands can be in one or more programming languages (e.g., in different programming languages), include one or more syntaxes, include one or more file formats, be interpretable by one or more CIEMs (e.g., by different CIEMs), be executable by one or more operating systems (e.g., by different operating systems), and/or be otherwise configured. The script is preferably a polyglot script, but can additionally or alternatively include commands in a single programming language (e.g., include commands for a single interpreter).

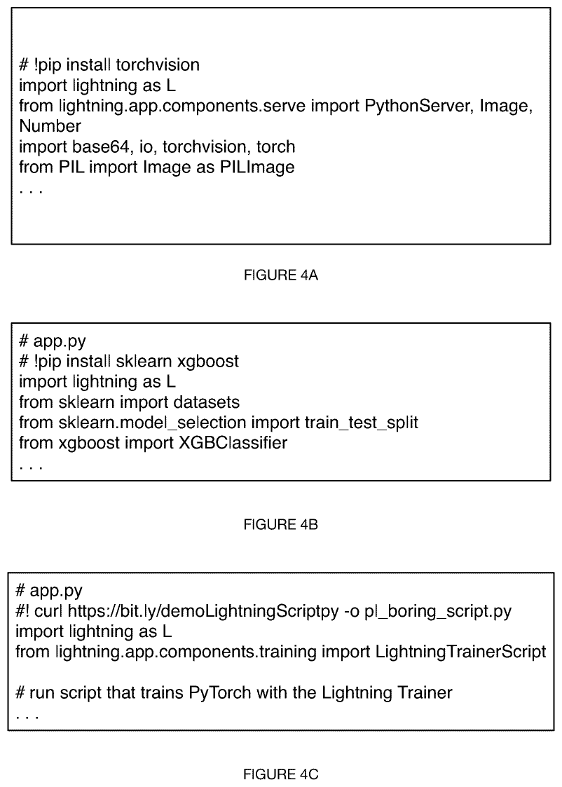

In an illustrative example, the base script can include both Python commands (e.g., the for the primary interpreter) and Bash commands (e.g., for the secondary interpreter); examples shown in FIG. 3, FIGS. 4A-4C, and FIG. 5.

The script can include one or more sets of commands. Different command sets can be delineated differently (e.g., include different lead characters, include reserved characters or special characters, etc.), be written in different programming languages, and/or be otherwise differentiated. For example, primary commands can lack special characters, while secondary commands can include special characters (e.g., as the leading characters in the script line with the commands, in the body of the script line, etc.).

Different command sets can additionally or alternatively include one or more command subsets. Different command subsets can be delineated differently (e.g., include different lead characters, include reserved characters or special characters, etc.), be written in different programming languages, be written in different formats, reference different computing resources, include different syntaxes and/or be otherwise differentiated. For example, the secondary command set can include a set of Mac commands and a set of Windows commands, wherein the commands can include different syntax (e.g., Mac syntax and Windows syntax, respectively); include OS-specific suffixes (e.g., “#!<command>#Windows” for Windows secondary commands; “#! <command>#Linux” for Linux or MacOS secondary commands; etc.); include conditionals in the special character line (e.g., “#! if(Windows)<Windows command>, else if(MacOS)<MacOS command>”); and/or otherwise distinguish between different command subsets. In an illustrative example, an executable may be written as “#!! mkdir NewDir”, wherein the command-line executable instructs the secondary interpreter to create a new directory while also specifying that it should be run on a particular operating system, such as MacOS in this example (e.g., “!” indicates the MacOS operating system). In operation, the CIEM (e.g., secondary CIEM) can determine which command subset to use (e.g., based on the host operating system), and ignore the other command subset(s). Alternatively, the CIEM (e.g., secondary CIEM) can translate the commands within the different command subsets into a unified command set (e.g., in the host operating system's syntax) before execution. This can enable the script and/or secondary commands to be written using any syntax. However, the script can include any other suitable number of commands, command sets, command subsets, and/or other command types.

The set of commands can include: a set of primary commands executable by a primary CIEM (e.g., primary interpreter, associated with the calling shell), a set of secondary commands executable by a secondary CIEM (e.g., secondary interpreter), and/or any other suitable set of commands (e.g., a third set of commands executable by a tertiary CIEM, etc.). The primary and nonprimary commands (e.g., secondary commands) are preferably located within the same script, but can additionally or alternatively be located in the same file, repository, folder, and/or any other suitable storage location.

In an illustrative example, the script can include a set of Python commands (e.g., the primary commands) and a set of Bash commands (e.g., secondary commands), wherein the Bash commands are prefixed by a special character (e.g., “#!”). In this illustrative example, the Bash commands can be executed first (e.g., preferentially, by a Bash interpreter or compiler or a Python subprocess), and the Python commands can be executed after the Bash commands (e.g., by a Python interpreter). However, the commands can be executed in any other suitable order.

The primary commands (e.g., primary interpreter directives, primary interpreter commands, etc.) can define the script's functionality (e.g., processes, calls, instructions, etc.), or include any other suitable information. All, a portion, or none of the primary commands (e.g., remainder of the base script; non-special character lines; etc.) can use information obtained using the secondary interpreter commands (e.g., calls functions from packages or libraries installed using the secondary interpreter commands, uses data loaded secondary interpreter commands, etc.); alternatively, the remainder of the base script can be otherwise related to the secondary interpreter commands.

The secondary commands (e.g., secondary interpreter directives, secondary primary interpreter commands, etc.) can specify: computing environment setup (e.g., dependency installations, library installations, package installations, program installations, virtual machine setup, container setup, etc.), which primary CIEM to use, command-line commands, project-specific commands (e.g., tasks), and/or other instructions. In specific examples, this can be done without calling “sys.executable”, and/or other standard calls within the secondary command and/or the special character line; alternatively, standard calls can be used. In examples, this can remove the need for the script to be distributed (e.g., shipped, sent, paired, etc.) with a separate requirements text file delineating all necessary packages, documentation of package and project dependency settlement, a precomputed image of the computing environment, and/or other attendant files (e.g., the script can include all information needed to set up the computing environment and execute the primary commands).

The non-primary commands (e.g., the secondary commands, tertiary commands, etc.) can be: wrapped, preceded, prefixed, or otherwise associated with a set of special characters; be located within a predetermined (e.g., reserved) position within the script (e.g., the beginning N lines of the script, etc.); and/or be otherwise identified.

When special characters are used, the special characters function to indicate that the text blob following the special character should be interpreted as a set of commands (e.g., secondary commands) for a secondary CIEM (e.g., a secondary interpreter; different from the primary CIEM; etc.), but can be otherwise interpreted. The special character can include one or more characters (e.g., include a specific sequence of individual characters). The special character can include alphanumeric characters, non-alphanumeric characters, and/or any other suitable character. The special character (e.g., magic number) is preferably a “#!” (e.g., hashbang, shebang, sharp-exclamation, pound-bang, hash-pling, etc.) or a “#!”, but can additionally or alternatively include “* . . . —*-/%+“&” or combinations thereof (e.g., “//!”, “/!”, “>>”, “+”, “$”, “$$”, “%”, “%%”, triple quotes, etc.), and/or any other suitable set of characters. The special character preferably includes a comment marker (e.g., “#”, “/*”, “//” etc.) as the leading character, such that the primary CIEM (e.g., primary interpreter) ignores the secondary commands following the special character as a comment. Alternatively, the primary CIEM (e.g., primary interpreter) can interpret the special character as a command to call the secondary CIEM (e.g., secondary interpreter) (e.g., wherein the primary interpreter can route the subsequent commands to the secondary interpreter or ignore the subsequent commands), or otherwise interpret the special character. The trailing character (e.g., second character, third character, etc.) in the special character can be any reserved character, such as “!”, “ ”, “˜”, “#”, “$”, and/or any other suitable character, examples shown in FIGS. 4A, 4B, and 4C. Whitespace after the second character (e.g., before the secondary interpreter command) can be optional.

The special character(s) can additionally or alternatively map to a secondary CIEM. For example, “#!” can map to a Bash shell or interpreter, while “##” can map to a different shell or interpreter, such as a tcsh, ksh, or zsh shell.

The method is preferably used with one special character, but can alternatively be used with multiple special characters (e.g., wherein different special characters can map to different secondary interpreters, different interpretation methods, operating systems, kernels, etc.).

The special character lines can be limited to: only the first line of the base script, only the first lines of the base script, a secondary command location within the base script (e.g., beginning, middle, end, etc.), and/or anywhere in the base script. The special character lines can be required to be clustered together, or be interspersed within the base script.

One or more secondary commands can follow an instance of a special character. The secondary commands associated with the special character instance can be located on the same line as the special character, be located on a different line (e.g., a subsequent line, sequential or adjacent line, nonsequential line, etc.) from the special character, and/or be otherwise associated with the special character. Different secondary commands (e.g., character-delineated text blobs) associated with the same special character instance can be delineated: logically (e.g., wherein the secondary command follows a standard format, and the end of the standard format delineates the end of the secondary command), by a character (e.g., “,”, “;”, “/”, “&”, etc.), by a set of characters (e.g., brackets, “{ }”, “( )”, “[ ]”; “AND”, “NEXT”, etc.), by whitespace, and/or otherwise delineated. The command-delineating character is preferably not a line break (e.g., such that the primary interpreter will interpret the remainder of the script in a standard manner), but can alternatively be a line break. Additionally or alternatively, special character instance can be followed by a single secondary command.

Sequential secondary commands (e.g., read left to right) are preferably passed to the secondary interpreter sequentially (e.g., in order of appearance, in logical order, etc.); alternatively, they can be passed at the same time or in any other suitable order.

The special character line preferably does not include a secondary interpreter identifier (e.g., excludes a secondary interpreter path), but can alternatively include a secondary interpreter identifier (e.g., as the first text blob following the special character, etc.).

However, the secondary commands can be otherwise identified and/or executed.

However, the scripts can be otherwise configured.

The system can be used with or include one or more computer instruction execution modules (CIEM), which function to parse, classify, execute, and/or otherwise manage one or more lines of the script. A CIEM can be: a loader, linker, assembler, compiler (e.g., configured to parse commands into machine code, then execute the commands as a batch), interpreter (e.g., configured to parse and execute commands in real-time), shell, kernel, application, and/or any other suitable computer instruction execution module. The CIEM can be custom (e.g., a custom Python loader, a custom Python interpreter, etc.), third-party standard (e.g., provided by the respective programming language developers, such as a standard Python interpreter, etc.), OS-standard (e.g., provided by the operating system, such as a Bash interpreter, UNIX loader, etc.), or be otherwise configured.

The computer instruction execution module is preferably compatible with a variety of computing environments, operating systems, PATHs, Linux systems, and/or other computing environments (e.g., cross-operating system capability); alternatively, the computer instruction execution module can be specific to a computing environment.

In variants, the system can include a primary CIEM and one or more secondary CIEMs. The primary CIEM and secondary CIEM are preferably different applications, but can alternatively be included in the same application.

The primary CIEM of the system functions to execute instructions (e.g., the commands, the primary commands, etc.) written in a programming or scripting language. The primary CIEM preferably executes the set of primary commands in the script, but can additionally or alternatively: execute the set of secondary commands in the script, identify the secondary commands in the script, route the secondary commands to the secondary CIEM (e.g., command by command; line by line; as a set of commands; etc.; example shown in FIG. 3), ignore the secondary commands in the script, and/or perform any other suitable set of functionalities. The primary CIEM preferably parses the script and directly executes the instructions (e.g., immediately, line by line), but can alternatively translate the script instructions into an intermediate representation or object code and execute the intermediate representation or object code; execute precompiled bytecode; and/or otherwise execute the instructions. The primary CIEM preferably parses and executes the script line-by-line, but can additionally or alternatively parse the script as a whole, then execute the script after parsing. The primary CIEM can parse: all lines of the script, only the primary commands (e.g., only lines of the script written in the language associated with the primary CIEM, only lines of the script without the special character, etc.), lines within a predetermined section of the script (e.g., top section, second section, section defined by a section identifier, etc.), and/or any other suitable set of lines.

The primary CIEM can be: a preloaded (e.g., preinstalled) CIEM (e.g., included by default in the operating system, loaded by a user, etc.), a web-based CIEM (e.g., browser-based CIEM, online CIEM, etc.), a standard CIEM, a third-party CIEM (e.g., provided by a third party), a wrapper around a pre-existing CIEM, and/or any other suitable CIEM. Examples of the primary CIEM can include: a Python interpreter (e.g., associated with an iPython “kernel”, which is a shell and not a true kernel; etc.), Perl interpreter, Raku interpreter, MATLAB interpreter, Ruby interpreter, UNIX-native interpreter (e.g., an interpreter that UNIX ships with, such as Bash), JAVA interpreter, and/or any other suitable interpreter, shell, or CIEM. In an illustrative example, the primary CIEM can be a web-based CIEM, wherein the script is uploaded into the web interface, wherein the web interface (e.g., web application, browser application, etc.) can parse the script and pass commands to a local process for execution. Additionally or alternatively, the web interface can pass commands to a remote process (e.g., a cloud process) for execution. However, other CIEMs can be used.

A primary CIEM can be associated with (e.g., specific to): a shell, an operating system, a kernel, a programming language, a virtual machine, a set of subprocesses, and/or any other suitable computing environment or context, or be generic across multiple computing environments or contexts. The primary CIEM is preferably cross-platform (e.g., compatible with multiple operating systems, multiple kernels, etc.), but can additionally or alternatively be specific to a subset or single platform (e.g., only MacOS, only Windows, etc.). In examples, the primary CIEM can have different CIEM versions for different platforms; be associated with (e.g., use) a set of subprocess implementations, each specific to a different platform; be associated with a cross-platform subprocess (e.g., agnostic to the platform); and/or be otherwise compatible with different computing platforms. The CIEM version or subprocess implementation to use can be selected based on: the respective platform executing the CIEM; instructions received from the user (e.g., wherein the user runs or calls the script using the selected primary CIEM); commands within the script (e.g., wherein the secondary commands or primary commands can explicitly specify which primary CIEM to use; wherein the platform is inferred from a platform-specific secondary command format or language; etc.), and/or otherwise determined. The primary CIEM is preferably not identified in the script, but can additionally or alternatively be identified in the script (e.g., by the secondary commands). However, the primary CIEM can be otherwise adapted for different computing environments.

The system can be used with one or more primary CIEMs. The primary CIEM that is used can be selected: by the user running the script, based on the script's primary programming language (e.g., the programming language for the primary commands), based on the computing system's operating system or kernel, by the special character line (e.g., wherein the special character line identifies the primary CIEM to use for the primary commands), or otherwise determined.

A primary CIEM can be associated with one or more secondary CIEMs. The associated secondary CIEM can be: preassociated with the primary CIEM, identified by a primary command, identified by the user, determined based on the operating system, and/or otherwise determined. The primary CIEM can control secondary CIEM operation (e.g., call the secondary CIEM, optionally with the secondary command, etc.), or execute alongside the secondary CIEM (e.g., wherein the primary CIEM and secondary CIEM have little or no interaction).

In variants, the primary CIEM can be used with or be replaced by a primary compiler (e.g., and an assembler and linker), wherein the primary compiler can compile the primary commands in the script into machine code. In variants, the primary compiler can additionally or alternatively: identify the secondary commands, compile the secondary commands into machine code, route the secondary commands to a secondary CIEM (or secondary compiler), and/or perform other functions. The primary compiler can have similar properties to the primary CIEM (e.g., be generic or specific to a computing environment, etc.), or have different properties from the primary CIEM. However, other primary CIEM alternatives can be used. Hereinafter, references to the primary CIEM can be understood to apply to primary CIEM alternatives, such as a primary compiler, except to the extent that the material is inconsistent with how the primary CIEM alternative functions.

However, the primary CIEM can be otherwise configured.

The secondary CIEM (e.g., secondary interpreter, custom loader, custom interpreter, etc.) of the system functions to execute instructions (e.g., the commands, the secondary commands, etc.) written in a programming or scripting language. The secondary CIEM is preferably different from the primary CIEM, but can alternatively be the same. The language that is interpreted by the secondary CIEM is preferably different from the language interpreted by the primary CIEM, but can additionally or alternatively be the same language. The secondary CIEM preferably executes the set of secondary commands in the script, but can additionally or alternatively identify the secondary commands in the script, execute the set of primary commands in the script, identify the primary commands in the script, route the primary commands to the primary CIEM (e.g., command by command; line by line; as a set of commands; etc.), ignore the primary commands, and/or perform any other suitable set of functionalities.

The secondary commands (e.g., secondary interpreter directive) can be: commands located within script lines that include the special character (“special character line”), commands within script lines ignored by the primary CIEM, commands within script lines treated as comments by the primary CIEM, commands within script lines identified by the user (e.g., user-selected script lines, etc.), and/or commands within any other suitable set of script lines. The secondary CIEM preferably parses the script and directly executes the instructions (e.g., line by line), but can alternatively translate the script instructions into an intermediate representation or object code and execute the intermediate representation or object code; execute precompiled bytecode; and/or otherwise execute the instructions. The secondary CIEM preferably parses and executes the script line-by-line, but can additionally or alternatively parse the script as a whole, then execute the script after parsing. The secondary CIEM can parse, identify, and/or execute: all special character lines before any primary commands are executed (e.g., before the primary CIEM parses or executes any commands); a subset of special character lines at a time; and/or in any other suitable order relative to primary CIEM command line execution. The secondary CIEM can parse: all lines of the script, only the secondary commands (e.g., only lines of the script written in the language associated with the secondary CIEM, only lines of the script with the special character, etc.), lines within a predetermined section of the script (e.g., top section, second section, section defined by a section identifier, etc.), and/or any other suitable set of lines.

The secondary CIEM is preferably a standard CIEM (e.g., standard interpreter), but can alternatively be a custom CIEM (e.g., custom interpreter). The secondary CIEM can be: a preloaded CIEM (e.g., included by default in the operating system, loaded by a user, etc.), a web-based CIEM (e.g., browser-based CIEM, online CIEM, etc.), a standard CIEM, a third-party CIEM (e.g., provided by a third party), a wrapper around a pre-existing CIEM, and/or any other suitable CIEM. The secondary CIEM is preferably different from the primary CIEM (e.g., a different program), but can additionally or alternatively be part of the primary CIEM and/or be the primary CIEM. Examples of the secondary CIEM can include: a Bash interpreter, Z Shell (zsh) interpreter, Bourne shell interpreter, C shell interpreter, TENEX C shell (tcsh) interpreter, Korn Shell (ksh) interpreter, Debian Almquist shell interpreter, Friendly interactive shell interpreter, Unix interpreter, Linux interpreter, Python interpreter (e.g., associated with an iPython “kernel”, which is a shell and not a true kernel; etc.), Perl interpreter, Raku interpreter, MATLAB interpreter, Ruby interpreter, and/or any other suitable interpreter, shell, terminal, other front-end interface for the secondary interpreter (e.g., Bash shell, Bash terminal, etc.), or CIEM. In an illustrative example, the secondary CIEM can be a web-based CIEM, wherein the script is uploaded into the web interface, wherein the web interface (e.g., web application, browser application, etc.) can parse the script and pass commands to a local process for execution. Additionally or alternatively, the web interface can pass commands to a remote process (e.g., a cloud process) for execution. The secondary CIEM is preferably a different CIEM from the primary CIEM, but can alternatively be the same CIEM (e.g., same type of CIEM, same CIEM instance, etc.). However, other CIEMs can be used.

A secondary CIEM can be associated with (e.g., specific to): a shell, an operating system, a kernel, a programming language, a virtual machine, a set of subprocesses, the primary CIEM (e.g., wherein the primary CIEM and secondary CIEM share a primary-secondary or principal-agent relationship, respectively), and/or any other suitable computing environment or context, or be generic across multiple computing environments or contexts. The secondary CIEM is preferably cross-platform (e.g., compatible with multiple operating systems, multiple kernels, etc.), but can additionally or alternatively be specific to a subset or single platform (e.g., only MacOS, only Windows, etc.). In examples, the secondary CIEM can have different CIEM versions for different platforms; be associated with (e.g., use) a set of subprocess implementations, each specific to a different platform; be associated with a cross-platform subprocess (e.g., agnostic to the platform); and/or be otherwise compatible with different computing platforms.

The secondary CIEM version or subprocess implementation that is used can be a default CIEM (e.g., predetermined interpreter; not specified within the special character line, wherein the special character line does not include an interpreter program name or path; etc.); be determined or selected based on: the respective platform executing the CIEM, instructions received from the user, commands within the script (e.g., wherein the secondary commands or secondary commands can explicitly specify which secondary CIEM to use; wherein the platform is inferred from a platform-specific secondary command format or language; etc.), be an interpreter program specified by the special character line (e.g., by an absolute path, a path searched for using the “env” program, etc.), and/or otherwise determined. The secondary CIEM version can be selected by the primary CIEM, a third CIEM (e.g., coordinating primary and secondary CIEM execution, etc.), and/or by any other suitable system. For example, if a custom loader detects the secondary commands are Windows commands, a secondary interpreter for the Microsoft Windows operating system will be chosen from a set of secondary interpreters including those for Microsoft Windows, Apple MacOS, Linux OS, Apple IOS, Google Android, and/or any other suitable operating system. However, the secondary CIEM can be otherwise adapted for different computing environments.

The system can be used with one or more secondary CIEMs (e.g., secondary interpreters). The secondary CIEM that is used can be selected: by the user running the script, based on the script's secondary programming language (e.g., the programming language for the secondary commands), based on the computing system's operating system or kernel, by the primary CIEM (e.g., wherein the secondary CIEM is paired with the primary CIEM or is a default secondary CIEM for the primary CIEM), be specified by the special character line (e.g., wherein the special character line identifies the secondary CIEM in addition to optional arguments), or be otherwise determined. Each secondary CIEM can be associated with one or more primary CIEMs.

In variants, the secondary CIEM can be used with or be replaced by a secondary compiler (e.g., and an assembler and linker), wherein the secondary compiler can compile the secondary commands in the script into machine code; a command processor; a shell; and/or any other suitable program. In variants, the secondary compiler can additionally or alternatively: identify the secondary commands, compile the secondary commands into machine code, route the secondary commands to a secondary CIEM (or secondary compiler), and/or perform other functions. The secondary compiler can have similar properties to the secondary CIEM (e.g., be generic or specific to a computing environment, etc.), or have different properties from the secondary CIEM. However, other secondary CIEM alternatives can be used. Hereinafter, references to the secondary CIEM can be understood to apply to secondary CIEM alternatives, such as a secondary compiler, secondary loader, secondary shell, or other alternatives, except to the extent that the material is inconsistent with how the secondary CIEM alternative functions.

However, the secondary CIEM can be otherwise configured.

The system can additionally or alternatively include other auxiliary CIEMs (e.g., secondary CIEMs) for other commands within the script (e.g., for tertiary commands, quaternary commands, etc.), or include no additional auxiliary CIEMs.

In variants, the system can additionally or alternatively include or be used with a loader that functions to load programs and libraries used by the script. The loader can be a standard loader (e.g., be part of the operating system), a custom loader, and/or be any other suitable loader. The loader can interact with the secondary CIEM, primary CIEM, the script, and/or any other suitable component. In an example, the secondary CIEM can instruct the loader to load or install dependencies, packages, libraries, and/or other programs identified by the secondary commands, wherein the installed programs or resources can be used by the primary commands (e.g., the methods or processes can be called by the primary commands). However, the loader can be otherwise used.

The primary and secondary CIEMs preferably cooperatively execute the set of commands within the script. The primary and secondary CIEMs can be executed: in a predetermined order (e.g., primary CIEM first, then secondary CIEM; secondary CIEM first, then primary CIEM); concurrently (e.g., the script is concurrently parsed and executed by the primary and secondary CIEMs); in script line order (e.g., the primary and secondary CIEM execution order is dependent on the order in which the primary and secondary commands appear in the script, respectively); based on a hierarchy (e.g., the primary CIEM controls or calls the secondary CIEM when a candidate special character line is encountered); and/or in any other suitable order.

In a first example, the primary CIEM can: parse a line of the script, determine whether the line includes a special character, route the line (or portion thereof) to the secondary CIEM for execution when a special character is detected in the line (e.g., at the beginning of the line, in the line body, etc.) or when the line is classified as a candidate special character line (e.g., based on the inclusion of a special character in the line, based on classification as a script comment due to inclusion of a reserved comment delineator, based on classification by a neural network, etc.), execute or compile the line (e.g., the commands within the line) when the line does not include a special character, and repeat the process with the subsequent line. The primary CIEM can wait for the second CIEM to complete execution before continuing with the remainder of the script, or immediately continue parsing and executing the remainder of the script.

In a second example, the primary CIEM can parse each line in the script, aggregate the lines containing the special character, and route the aggregated special character lines to the secondary CIEM for execution. The primary CIEM can execute each non-special character line immediately after the line is parsed, execute the lines after the aggregated special character lines have been sent to the secondary CIEM, execute the lines after the aggregated special character lines have been executed by the secondary CIEM, and/or execute the lines at any other suitable time.

In a third example, the secondary CIEM can parse the script before the primary CIEM. In this example, the secondary CIEM can parse a line of the script, identify whether the line includes a special character (e.g., whether the line is a special character line), and execute the special character lines (e.g., execute the commands within the line). The secondary CIEM can optionally identify primary commands (e.g., lines without special characters) and pass the primary commands to the primary CIEM (e.g., asynchronously after secondary command execution or in real-time during parsing), or ignore the primary commands. The secondary CIEM can parse, identify, and execute the special character lines: before the primary CIEM parses and executes the remainder of the script; on a line-by-line basis; and/or in any other suitable order with the primary CIEM. In an example, the secondary CIEM parses a given line first, then the primary CIEM parses the line (e.g., if the line is not a special character line; even if the line is a special character line; etc.) before the secondary CIEM parses the next line.

In a fourth example, the primary and secondary CIEM can parse and execute the script (e.g., identify the respective commands) contemporaneously (e.g., in parallel).

In a fifth example, a third CIEM (e.g., application, loader, etc.) can parse each line of the script and coordinate special character line and non-special character line execution by the secondary CIEM and the primary CIEM, respectively. For example, the third CIEM can identify and route special character lines from the script to the secondary CIEM first, then route the remainder or entirety of the scrip to the primary CIEM for execution.

However, execution of the primary and secondary commands can be otherwise coordinated between the primary and secondary CIEMs, respectively.

In an illustrative example, an example script can include a first set of special character lines (e.g., including one or more special character lines) followed by a first set of primary command lines (e.g., including one or more primary command lines) followed by a second set of special character lines (e.g., including one or more special character lines). In this example, the first set of special character lines can be executed by the secondary CIEM first, then the first set of primary command lines is executed by the primary CIEM, then the second set of special character lines is executed by the secondary CIEM. Alternatively, the secondary CIEM can execute the first and second set of special character lines first, then the primary CIEM can execute the first set of primary command lines. The first and second set of special character lines can be identified by the primary CIEM (e.g., wherein the primary CIEM parses the script first) or by the secondary CIEM (e.g., wherein the secondary CIEM parses the script first). However, the lines can be executed in any other suitable order.

However, primary and secondary CIEM usage (e.g., parsing and/or execution) can be otherwise coordinated.

However, the system can be used with or include any other suitable set of components.

### 4. Method

In variants, as shown in FIG. 1, the method can include: identifying a line including a special character in a base script S100; executing a secondary CIEM associated with the special character S200; executing commands within the special character line using the secondary CIEM S300; optionally repeating S100-S300 for subsequent lines in the base script including the special character S400; and executing the remainder of the base script using a primary CIEM S500.

All or portions of the method can be performed: in real time (e.g., responsive to a request to run a script), asynchronously, iteratively, sequentially, concurrently, or at any other suitable time. All or portions of the method can be performed during each iteration of the method. All or portions of the method can be executed: when a script is run; every time the computer instruction execution module is used; when a special flag is passed as an argument during base script execution (e.g., “- - setup”; example shown in FIG. 5); and/or at any other suitable time.

All or portions of the method can be performed: automatically, manually, semi-automatically, and/or otherwise performed. All or portions of the method are preferably performed using the system described above, but can additionally or alternatively be performed using any other suitable system.

Identifying a line including a special character (special character line) in a base script S100 functions to identify lines containing secondary interpreter directives. S100 preferably includes identifying one or more lines starting with a special character in the base script, but can additionally or alternatively identify one or more lines that include a special character in the body of the line (e.g., after the beginning of the line, in the middle of the line, at the end of the line, etc.), and/or identify any other suitable indicator that the line is a special character line. The special character line can be identified by the program loader, by an interpreter (e.g., primary interpreter, secondary interpreter), by the exec family of functions, by the primary CIEM, by the secondary CIEM, by a coordinating CIEM (e.g., a loader), and/or by any other suitable module. The exec family of functions refers to functions of an operating system that runs an executable file in the context of an already existing process, replacing the previous executable. As no new process is created, the process identifier does not change, but the machine code of the process, among other data, are replaced by those of the new program. The exec call is available for many programming languages. The special character line can be identified during script loading, script compilation, script execution, script interpretation, and/or at any other suitable time. Special character lines can be identified one at a time (e.g., during execution; during each iteration of the method), at the same time (e.g., during script loading), and/or otherwise identified. In an example, a line starting with “#!” can be identified in a Python script. However, the special character line can be otherwise identified.

Executing a secondary CIEM associated with the special character S200 functions to initialize a secondary CIEM instance (e.g., secondary interpreter session or instance) that can be used to execute the secondary commands (e.g., commands within the special character lines). S200 is preferably performed after the first special character line is identified (e.g., after the first instance of S100 for a given base script), but can alternatively be performed each time a special character line is identified in the base script, performed when the primary CIEM instance is initialized (e.g., when the primary CIEM is opened, executed, etc.), always running in the background (e.g., as a background process), and/or performed at any other suitable time. The secondary interpreter session or instance can: be persistent during base script execution (e.g., which can persist the secondary interpreter state throughout base script execution, such that subsequent secondary interpreter commands in the base script are executed based off the persisted state); be terminated after the commands from a single special character line are executed; be terminated after the commands from a set of special character lines (e.g., adjacent special character lines, all special character lines in the script, etc.) are executed; and/or terminated at any other suitable time. The secondary interpreter program is preferably a default interpreter (e.g., an interpreter that is always used to interpret the special character lines), but can alternatively be an interpreter program specified in the special character line (e.g., by an absolute path, a path identified using the “env” search, etc.), be an interpreter located at a default path in the environment (e.g., an interpreter located at “/usr/bin/bash”, a call that uses the “env” program to run the interpreter, such as “/usr/bin/env bash”, etc.), or be any other suitable interpreter. In an example, a Bash shell or Bash interpreter is executed when a special character line is detected in the base script (e.g., wherein the special character can be interpreted as “/usr/bin/bash” or “/usr/bin/env bash”).

In some variants, extra parameters (e.g., default parameter values, subsequent secondary commands from the same or different script lines, etc.) can be passed after the declaration of the interpreter. Alternatively, some variants can exclude additional parameters within the interpreter declaration, as the system may read the text blob following the special character as a single command.

However, S200 can be otherwise performed.

Executing commands within the special character line using the secondary CIEM S300 functions to implement the secondary commands. The secondary commands are preferably commands following the special character within the identified line (e.g., the special character line, the line identified in S100, etc.), but can additionally or alternatively be commands located before the special character in the identified line, be commands associated with the special character in the identified line (e.g., commands within a parenthetical or bracketed set following the special character), be commands located within a different line from the identified line (e.g., a command in an indented line following the identified line, etc.), and/or be otherwise arranged relative to or associated with the special character. The commands are preferably executed using the secondary CIEM (e.g., initialized in S200), but can alternatively be executed using any other suitable CIEM. The commands from a single special character line are preferably passed one by one (e.g., sequentially) to the secondary CIEM (e.g., secondary interpreter), but can alternatively be passed all at once, passed as blocks (e.g., wherein a block can include secondary commands from contiguous script lines; secondary commands from a predetermined number of script lines; etc.), and/or otherwise passed to the secondary CIEM. The commands from multiple special character lines are preferably passed one by one (e.g., sequentially, in script order, etc.) to the secondary CIEM, but can alternatively be passed all at once. For instance, a special character line can include “#! pip install numpy”, wherein the secondary command calls a particular package, “numpy”, to be installed into the Python project. The secondary CIEM can then receive and execute the secondary command to install the package into the Python project. In another example, multiple secondary commands can be passed all at once to the secondary CIEM. In an illustrative example, the following secondary commands can be passed to the secondary CIEM: “#! pip install numpy && pip install moviepy && mkdir NewFolder”. In this illustrative example, three secondary commands (e.g., executables) are passed to the secondary CIEM all at once, wherein two executables are installing Python packages and one is a cross-operating system command to create a new directory (e.g., folder). Commands can be passed to the secondary interpreter and interpreted by the secondary interpreter line by line in sequence, or all at once, or in any other suitable interpretation otherwise. Base script loading and/or execution is preferably paused until secondary command execution completion, but can alternatively be loaded or executed concurrently and/or otherwise managed. In an example, character-delineated text blobs following the special character are sequentially passed to the secondary CIEM (e.g., Bash interpreter) for execution (e.g., example shown in FIG. 3), but can alternatively be passed concurrently to the secondary CIEM, wherein the secondary CIEM can determine the secondary command execution order. However, the secondary interpreter commands can be otherwise executed.

The method can optionally include repeating S100-S300 for subsequent lines in the base script including the special character (e.g., special character lines) S400. Alternatively, only S100 and S300 are repeated for subsequent special character lines in the base script (e.g., wherein subsequent instances of S300 use the secondary CIEM instance initialized in S200). All subsequent instances of S100-S300 (e.g., with or without subsequent instances of S200) can be performed: before any instance of S500 (e.g., before any primary commands are executed); intermingled with S500 (e.g., wherein each line is parsed for a special character first before execution using S500; wherein S100-S300 are run on a line first before passing the line through S500; etc.); executed concurrently with S500 (e.g., wherein the same line is passed through S100-S300 and S500 at substantially the same time); and/or performed in any other suitable order relative to S500. However, any other suitable portion of the method can be repeated for subsequent special character lines, and/or performed in any other suitable order.

Subsequent special character lines are preferably executed sequentially (e.g., in the order they appear in the base script), but can alternatively be executed randomly, in an order determined by the secondary CIEM (e.g., secondary interpreter), and/or in any other suitable order. Subsequent special character lines can be executed before base script execution, executed in sequence with the base script (e.g., the base script is executed until the subsequent special character line is reached, at which point the subsequent special character line is executed), and/or executed in any other suitable order relative to base script execution.

Subsequent instances of S100 preferably identify the same special character, but can alternatively identify different special characters. Subsequent instances of S200 and/or S300 preferably use the same secondary CIEM (e.g., secondary interpreter), but can alternatively use different secondary interpreters. For example, a different special character can execute a different secondary interpreter in S200. In another example, a subsequent special character line can identify a specific interpreter program, which can be executed used in lieu of the default interpreter (e.g., in the corresponding instances of S200 and S300). Alternatively, the specific interpreter can be used to only execute the secondary commands on said special character line, wherein subsequent special character lines (e.g., following the line with the specific interpreter) can be executed by the default interpreter. Commands from subsequent special character lines are preferably executed in the same session as that used in the initial S200 instance (e.g., example shown in FIG. 3), but can alternatively be executed in a different session of the secondary interpreter.

However, S100-S300 can be otherwise repeated.

Executing the remainder of the base script using a primary CIEM (e.g., primary interpreter) S500 functions to execute the main script. S500 can be executed after all special character lines have been executed, be executed in sequence with the special character lines, and/or otherwise executed. S500 is preferably automatically executed after S400 (e.g., without additional user input), but can alternatively be executed after user input receipt and/or at any other suitable time. The primary CIEM is preferably a primary CIEM that is identified by the user (e.g., wherein the user selects or calls the script within the primary CIEM), but can additionally or alternatively be specified by the secondary commands (e.g., the special character line “#! python3” causes the primary commands to be executed using a Python 3 interpreter), determined based on the computing environment (e.g., based on the host operating system), or otherwise determined.

S500 can include parsing all lines of the script and executing non-special character lines, parsing only the lines that were not executed by the secondary CIEM (e.g., parsing only non-special character lines), and/or otherwise identifying and executing the primary commands. The primary commands can be executed sequentially (e.g., in the order of appearance), in a different order from that appearing in the script (e.g., logical order, order dependent upon the dependencies installed by the secondary commands, order dictated by the secondary commands, etc.), and/or in any other suitable order. For example, the primary interpreter may reorganize the sequence of project dependency-related executables to optimize program execution efficiency. The commands may also be able to be offloaded and distributed across multiple threads for simultaneous execution, wherein wait conditions or dependencies can be placed to ensure installations of required packages are completed prior to relevant base script commands.

However, S500 can be otherwise performed.

In variants, once S500 completes execution of the remainder of the base script, the secondary CIEM can be offloaded or terminated, and no further executables may be routed. Alternatively, the secondary CIEM can be persisted as long as or after primary CIEM persistence, terminated after the last S300 instance (e.g., after the last secondary command) for the script, and/or terminated at any other suitable time. The primary CIEM can be terminated after base script execution completion (e.g., after all primary commands within the script are executed), but can additionally or alternatively be terminated upon user request (e.g., wherein the user closes the shell or interface), and/or be terminated at any other suitable time.

However, the polyglot script can be otherwise executed.

All references cited herein are incorporated by reference in their entireties, except to the extent that the incorporated material is inconsistent with the express disclosure herein, in which case the language in this disclosure controls.

Different processes and/or elements discussed above can be performed and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUS, TPUS, microprocessors, or ASICs, but the instructions can alternatively or additionally be executed by any suitable dedicated hardware device.

Embodiments of the system and/or method can include every combination and permutation of the various elements discussed above, and/or omit one or more of the discussed elements, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the embodiments of the invention without departing from the scope of this invention defined in the following claims.

We claim:

1. A method, comprising:
identifying special character line within a script, wherein the special character line comprises a special character and a set of secondary commands, and excludes an interpreter identifier;
executing the special character line using a secondary interpreter; and
executing a remainder of the script using a primary interpreter different from the secondary interpreter.

2. The method of claim 1, wherein the script is a single-file, self-contained script.

3. The method of claim 1, further comprising repeating special character line identification and execution for all special character lines in the script, wherein the remainder of the script is executed after all special character lines in the script are executed.

4. The method of claim 1, wherein the script is a polyglot script and comprises executable commands in at least two programming languages.

5. The method of claim 1, wherein the special character line specifies dependencies for the remainder of the script.

6. The method of claim 1, wherein the special character line comprises commands to install a set of programs, wherein the remainder of the script calls methods from the set of programs.

7. The method of claim 6, wherein the script is distributed without at least one of: a separate requirements file or a precomputed image of the computing environment.

8. The method of claim 1, wherein the special character line comprises multiple distinct executable commands, wherein the multiple distinct executable commands are executed sequentially by the secondary interpreter.

9. The method of claim 1, wherein the secondary interpreter is a Bash interpreter, and the primary interpreter is a Python interpreter.

10. The method of claim 1, further comprising:
determining a computing environment for script execution; and
automatically selecting the secondary interpreter based on the computing environment.

11. The method of claim 1, wherein the special character comprises a leading character that is interpreted as a comment by the primary interpreter.

12. The method of claim 1, wherein the special character is “#!”.

13. A system, comprising:
a secondary interpreter configured to execute a set of secondary commands within a set of special character lines within a polyglot script, wherein the special character lines are identified by a special character and does not identify the secondary interpreter; and
a primary interpreter configured to execute a set of primary commands within the polyglot script, wherein the primary commands are not identified by the special character.

14. The system of claim 13, wherein the primary interpreter is configured to parse the polyglot script.

15. The system of claim 13, wherein the primary interpreter executes the set of primary commands within a preconfigured computing environment, wherein the set of secondary commands preconfigures the computing environment.

16. The system of claim 15, wherein the polyglot script is a single file.

17. The system of claim 15, wherein the polyglot script is distributed without a precompiled image of the preconfigured computing environment and without a separate requirements file.

18. A system, comprising:
a single-file polyglot script, comprising a primary command set written in a first programming language and a secondary command set written in a second programming language, wherein secondary commands in the secondary command set are identified by a special character on respective script lines, wherein the secondary command set is executed by a secondary interpreter that is not identified by the script, and the primary command set is executed by a primary interpreter that is not identified by the script after the secondary command set is executed.

19. The system of claim 18, wherein the script comprises multiple secondary commands within a script line.

20. The system of claim 18, wherein the script is distributed without a precompiled image of the preconfigured computing environment and without a separate requirements file.
